(19) United States
(12) Patent Application Publication
(10) Pub. No.: US 2020/0406661 A1
(43) Pub. Date: Dec. 31, 2020

(54) CONTINUOUS MAZE BOOK DEVICE

(71) Applicant: Cary Boren, Riverside, CA (US)

(72) Inventor: Cary Boren, Riverside, CA (US)

(21) Appl. No.: 16/453,203

(22) Filed: Jun. 26, 2019

(51) Int. Cl. B42D 1/00

(52) U.S. Cl. CPC B42D 1/009; A63F 9/0641

(57) ABSTRACT

A continuous maze book device provides a maze having continuity through a series of pages. The pages have maze indicia displayed thereon in a sequential order. The pages include a starting page, a medial page, and an ending page. The maze indicia includes a start point and a starting page exit along a continuous starting page path. The maze indicia includes a medial page entry positioned corresponding to the starting page exit and a medial page exit. The maze indicia includes an ending page entry corresponding to the medial page exit. The maze indicia on the ending page includes an end point.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to maze devices and more particularly pertains to a new maze device for providing a maze having continuity through a series of pages.

### (2) Description of Related Art Including Information Disclosed Under 37 CFR 1.97 and 1.98

The prior art relates to maze devices.

### BRIEF SUMMARY OF THE INVENTION

An embodiment of the disclosure meets the needs presented above by generally comprising pages having maze indicia displayed thereon in a sequential order. The pages include a starting page, a medial page, and an ending page. The maze indicia includes a start point and a starting page exit along a continuous starting page path. The maze indicia includes a medial page entry positioned corresponding to the starting page exit and a medial page exit. The maze indicia includes an ending page entry corresponding to the medial page exit. The maze indicia on the ending page includes an end point.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a continuous maze book device according to an embodiment of the disclosure.

FIG. 2 is a front view of a starting page of an embodiment of the disclosure.

FIG. 3 is a front view of a medial page of an embodiment of the disclosure.

FIG. 4 is a front view of an ending page of an embodiment of the disclosure.

### DETAILED DESCRIPTION OF THE INVENTION

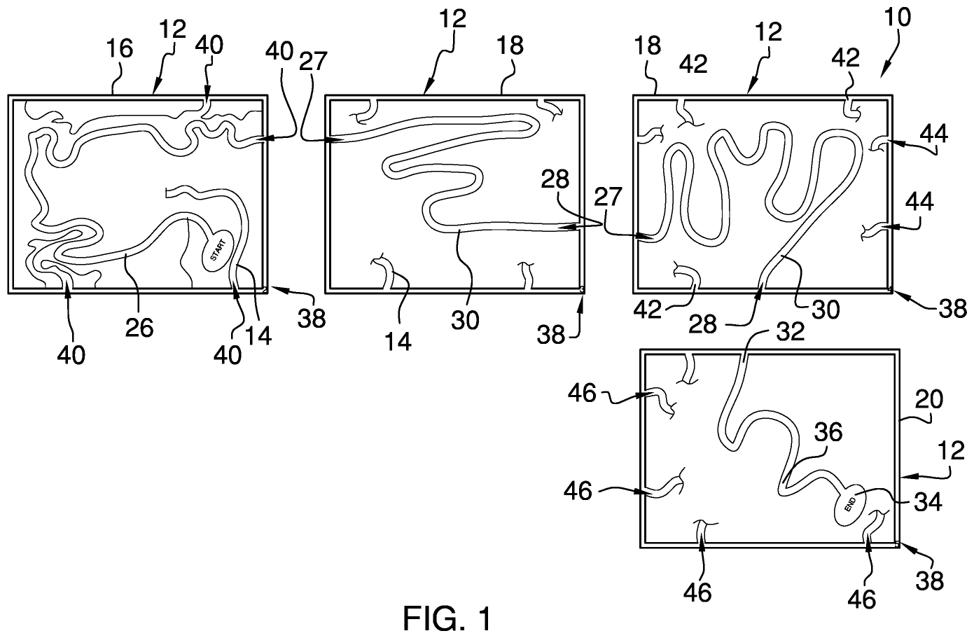

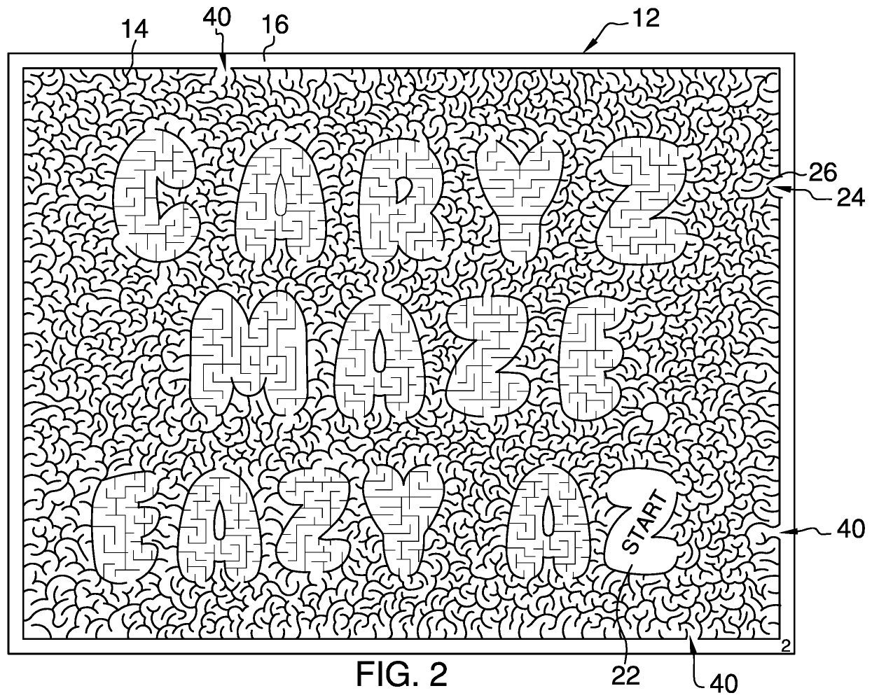

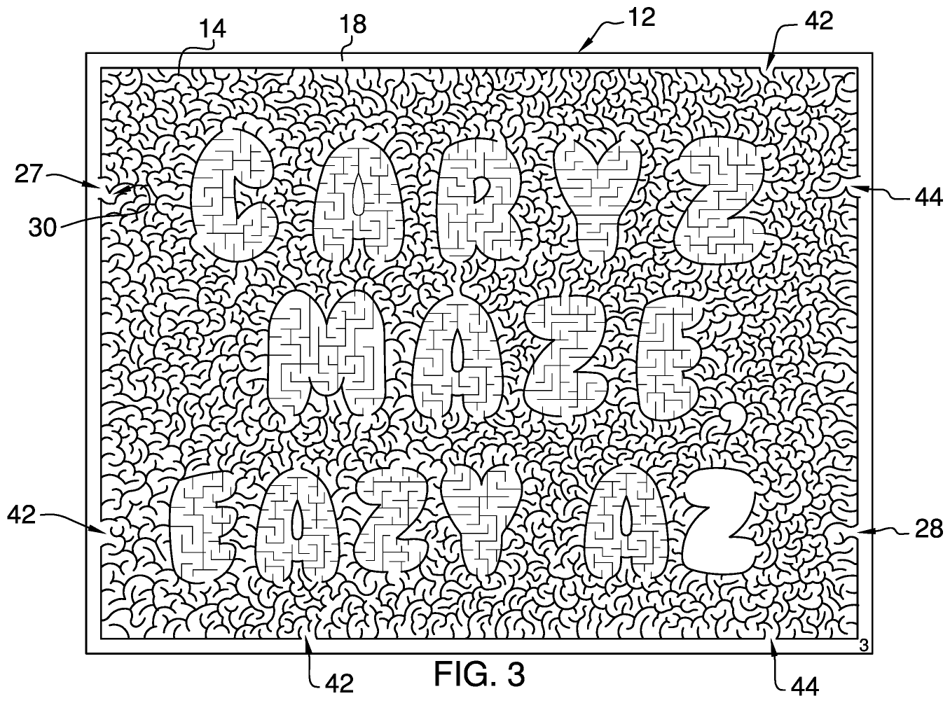

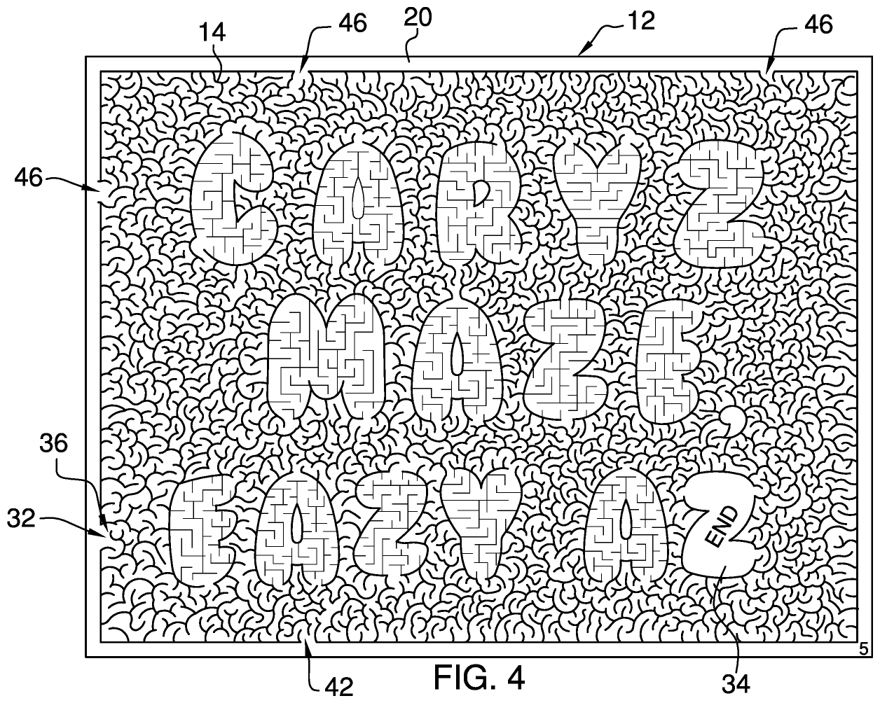

With reference now to the drawings, and in particular to FIGS. 1 through 4 thereof, a new maze device embodying the principles and concepts of an embodiment of the disclosure and generally designated by the reference numeral 10 will be described.

As best illustrated in FIGS. 1 through 4, the continuous maze book device 10 generally comprises a plurality of pages 12. Each of the pages 12 has maze indicia 14 displayed thereon. The maze indicia 14 generally comprises lines defining a path from a beginning to an end in the form of a labyrinth. The pages 12 are arranged into a sequential order. The specific order may be numbered. The plurality of pages 12 includes a starting page 16, a medial page 18, and an ending page 20. The pages 12 may provide for a plurality of medial pages 18 in sequence consistent with the description below for providing a continuous maze throughout the plurality of pages 12.

The maze indicia 14 on the starting page 16 includes a start point 22 and a starting page exit 24. The starting page exit 24 is along a continuous starting page path 26 extending from the start point 22 to the starting page exit 24. FIG. 1 is provided with most of the maze indicia 14 not shown for clarifying the interaction and alignment of sequential pages 12 consistent with the description below. Generally, the maze indicia 14 is not identical on each page and is representative in the drawing figures which each shown potentially different pages 12. The complexity of maze indicia 14 of each page 12 may be varied or provided with an intent to provide a consistent complexity or skill level which may be varied for different user ages or abilities.

The maze indicia 14 on the medial page 18 includes a medial page entry 27. The medial page entry 27 is positioned corresponding to the starting page exit 24 such that the medial page entry 27 would align with the starting page exit 24 if the start page 16 were positioned adjacently to the medial page 18 with the maze indicia 14 of the starting page 16 abutting and aligning with the maze indicia 14 of the medial page 18. The maze indicia 14 of the medial page 18 has a medial page exit 28. The maze indicia 14 on the medial page 18 defines a continuous medial page path 30 between the medial page entry 27 and the medial page exit 28.

The maze indicia 14 on the ending page 20 includes an ending page entry 32 and an end point 34. The ending page entry 32 is positioned corresponding to the medial page exit 28 such that the ending page entry 32 would align with the medial page exit 28 if the medial page 18 were positioned adjacently to the ending page 20 with the maze indicia 14 of the medial page 28 abutting and aligning with the maze indicia 14 of the ending page 20. The end point 34 is positioned at a terminal point of the path. The maze indicia 14 on the ending page 20 defines a continuous ending page path 36 between the ending page entry 32 and the end point 36.

The maze indicia 14 on the starting page 16 includes a plurality of false starting page exits 40. The maze indicia 14 on the medial page 18 includes a plurality of false medial page entries 42. Each false medial page entry 42 is positioned corresponding to an associated false starting page exit 40 such that the false medial page entry 42 would align with the associated false starting page exit 40 if the start page 16 were positioned adjacently to the medial page 18 with the maze indicia 14 of the starting page 16 abutting and aligning with the maze indicia 14 of the medial page 18 along respective sides of the starting page 16 and the medial page 18 including the false starting page exit 40 and the false medial page entry 42.

The maze indicia 14 on the medial page 18 includes a plurality of false medial page exits 44. The maze indicia 14 on the ending page 20 including a plurality of false ending page entries 46. Each false ending page entry 46 is positioned corresponding to an associated false medial page exit 44 such that the false ending page entry 46 would align with the associated false medial page exit 44 if the medial page 18 were positioned adjacently to the ending page 20 with the maze indicia 14 of the medial page 18 abutting and aligning with the maze indicia 14 of the ending page 20 along respective sides of the medial page 18 and the ending page 20 including the false medial page exit 44 and the false ending page entry 46. As the appearance of the false medial page entries 42 are visually indistinguishable from the false medial page exits 44, some of the false ending page entries 46 may also be positioned to align with the false medial page entries 42. In this way, there are no false medial page entries 42 unassociated with a possible false ending page entry 46 and the user cannot glean starting or ending potential for each opening on a medial page 18. Where more than one medial page 18 is provided, the above would be applied to adjacent or sequential medial pages 18 to disguise the nature of the openings on the edge of the maze indicia 14.

While the overall maze device 10 is provided for in sequentially arranged pages, there may be sequence indicia 38 positioned adjacent to the starting page exit 24, medial page entry 27, medial page exit 28, and ending page entry 32. The sequence indicia 38 may be provided in pairs of identical indicia by respective positions to indicate a specific pathway between the pages 12 which may or may not be adjacent to each other in the series of pages 12.

In use, the user starts by using a marker, pencil, or the like to draw a line from the starting point 22, finding the way along the starting page path 26 to the starting page exit 24. The user continues through the medial page 18 and on to the ending page 20. The maze device 10 may be considered segmented providing opportunities to take breaks between pages, but the positional relationships between each exit and entry provides for continuity in the path.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A continuous maze book device comprising:
a plurality of pages, each of said pages having maze indicia displayed thereon, said pages being arranged into a sequential order, said plurality of pages including a starting page, a medial page, and an ending page;
wherein said maze indicia on said starting page includes a start point and a starting page exit, said starting page exit being along a continuous starting page path extending from said start point to said starting page exit;
wherein said maze indicia on said medial page includes a medial page entry, said medial page entry being positioned corresponding to said starting page exit such that said medial page entry would align with said starting page exit when said start page is positioned adjacently to said medial page with said maze indicia of said starting page abutting and aligning with said maze indicia of said medial page, said maze indicia of said medial page having a medial page exit, said maze indicia on said medial page defining a continuous medial page path between said medial page entry and said medial page exit; and
wherein said maze indicia on said ending page includes an ending page entry and an end point, said ending page entry being positioned corresponding to said medial page exit such that said ending page entry would align with said medial page exit when said medial page is positioned adjacently to said ending page with said maze indicia of said medial page abutting and aligning with said maze indicia of said ending page, said ending page having an end point, said maze indicia on said ending page defining a continuous ending page path between said ending page entry and said end point.

2. The device of claim 1, further comprising said medial page being one of a plurality of said medial pages.

3. The device of claim 1, further comprising said maze indicia on said starting point including a plurality of false starting page exits, said maze indicia on said medial page including a plurality of false medial page entries, each false medial page entry being positioned corresponding to an associated false starting page exit such that said false medial page entry would align with said associated false starting page exit when said start page is positioned adjacently to said medial page with said maze indicia of said starting page abutting and aligning with said maze indicia of said medial page along respective sides of said starting page and said medial page including said false starting page exit and said false medial page entry.

4. The device of claim 1, further comprising said maze indicia on said medial page including a plurality of false medial page exits, said maze indicia on said ending page including a plurality of false ending page entries, each false ending page entry being positioned corresponding to an associated false medial page exit such that said false ending page entry would align with said associated false medial page exit when said medial page is positioned adjacently to said ending page with said maze indicia of said medial page abutting and aligning with said maze indicia of said ending page along respective sides of said medial page and said ending page including said false medial page exit and said false ending page entry.

5. A continuous maze book device comprising:
a plurality of pages, each of said pages having maze indicia displayed thereon, said pages being arranged into a sequential order, said plurality of pages including a starting page, a medial page, and an ending page;
wherein said maze indicia on said starting page includes a start point and a starting page exit, said starting page exit being along a continuous starting page path extending from said start point to said starting page exit;
wherein said maze indicia on said medial page includes a medial page entry, said medial page entry being positioned corresponding to said starting page exit such that said medial page entry would align with said starting page exit when said start page is positioned adjacently to said medial page with said maze indicia of said starting page abutting and aligning with said maze indicia of said medial page, said maze indicia of said medial page having a medial page exit, said maze indicia on said medial page defining a continuous medial page path between said medial page entry and said medial page exit;
wherein said maze indicia on said ending page includes an ending page entry and an end point, said ending page entry being positioned corresponding to said medial page exit such that said ending page entry would align with said medial page exit when said medial page is positioned adjacently to said ending page with said maze indicia of said medial page abutting and aligning with said maze indicia of said ending page, said ending page having an end point, said maze indicia on said ending page defining a continuous ending page path between said ending page entry and said end point;
wherein said maze indicia on said starting point includes a plurality of false starting page exits, said maze indicia on said medial page including a plurality of false medial page entries, each false medial page entry being positioned corresponding to an associated false starting page exit such that said false medial page entry would align with said associated false starting page exit when said start page is positioned adjacently to said medial page with said maze indicia of said starting page abutting and aligning with said maze indicia of said medial page along respective sides of said starting page and said medial page including said false starting page exit and said false medial page entry; and
wherein said maze indicia on said medial page includes a plurality of false medial page exits, said maze indicia on said ending page including a plurality of false ending page entries, each false ending page entry being positioned corresponding to an associated false medial page exit such that said false ending page entry would align with said associated false medial page exit when said medial page is positioned adjacently to said ending page with said maze indicia of said medial page abutting and aligning with said maze indicia of said ending page along respective sides of said medial page and said ending page including said false medial page exit and said false ending page entry.

6. The device of claim 5, further comprising said medial page being one of a plurality of said medial pages.
